(19) United States
(12) Patent Application Publication
(10) Pub. No.: US 2010/0330543 A1
(43) Pub. Date: Dec. 30, 2010

(54) METHOD AND SYSTEM FOR A CHILD REVIEW PROCESS WITHIN A NETWORKED COMMUNITY

(76) Inventors: Alexander Black, Berkeley, CA (US); Jon Savage Morse, Tiburon, CA (US); Hilary Decesare, Danville, CA (US)

Correspondence Address: SCHOX PLC, 500 3rd Street, Suite 515, San Francisco, CA, 94107, US

(21) Appl. No.: 12/822,434

(22) Filed: Jun. 24, 2010

Related U.S. Application Data
(60) Provisional application No. 61/220,194, filed on Jun. 24, 2009.

(51) Int. Cl. G09B 19/00

(52) U.S. Cl. 434/236

(57) ABSTRACT

A system and method for moderating child interaction in a networked community by a supervisor that includes monitoring interactions of a child within a first environment; selecting a child interaction that satisfies a notification parameter of the supervisor; and sending a notification to the supervisor within a second environment with information associated with the selected interaction.

### CROSS-REFERENCE TO RELATED APPLICATIONS

This application claims the benefit of U.S. Provisional Application No. 61/220,194, filed 24 Jun. 2009, entitled “METHOD AND SYSTEM FOR A PARENTAL REVIEW PROCESS WITHIN AN INTERNET COMMUNITY”, which is incorporated in its entirety by this reference.

### TECHNICAL FIELD

This invention relates generally to the network community field, and more specifically to a new and useful child review process in the internet community field.

### BACKGROUND

There are numerous rules and laws in place to protect children on the internet. The Children's Online Privacy Protection (COPPA) Act is one example. Among other requirements, the COPPA Act has put in place regulations for website operators concerning the personal information of children, and activity on online sites. While safety and protection of children is important to parents, many parents or guardians also want to be able to provide freedom to their children while maintaining assurance that children's activities are safe and fostering good lifestyle practices. Thus, there is a need in the network community field to create a new and useful child review process.

This invention provides such a new and useful method and system.

### BRIEF DESCRIPTION OF THE FIGURES

FIG. 1 is a flowchart representation of a method of a preferred embodiment of the invention;

FIG. 2 is a detailed schematic representation of a method of a preferred embodiment of the invention;

FIG. 3 is a schematic representation of a system of a preferred embodiment of the invention; and

FIGS. 4 and 5 are flowchart representations of creating initial settings in a community.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Method of the Preferred Embodiment

The method of the preferred embodiment, as shown in FIG. 1, includes the steps of monitoring interactions of a child in a community S110, selecting interactions of the child based on a notification parameter of a supervisor S120, and notifying the supervisor of actions of the child S130. The method may additionally include one or more of the following steps: creating a notification parameter defined by the supervisor S122, providing a response input interface in the notification S140, and receiving a supervisor response action S150, performing an action within the networked community associated with the supervisor response action S160, and dynamically modifying notification parameters based on input of the supervisor S170. The method functions to allow the activity of a child to be monitored and at times regulated or altered by a third party participant (referred to as the supervisor). The method preferably enables a supervisor to stay informed of behavior of a child within a networked community and also allows a supervisor to optionally step in to take action if warranted by a particular interaction of a child. The method preferably facilitates the act of parenting in a networked community. A networked community preferably includes any children focused community operated through a technology network. In particular, the method has been designed for use with a child that is participating in an internet community. The internet community may be any suitable network such as a social network, virtual community, a forum, an online game, a massively multiplayer online role playing game (MMORPG), messaging service, membership/account based internet service such as email, instant messaging (IM) platform, a blog, or any suitable online community. The method may additionally be expanded for application in non-internet based networked communities such as telephone plans or Short Messaging Services (SMS). A community may additionally have integration with a plurality of networks such as an internet-based social network integrated with a SMS network. The user is preferably a child or under-aged user, such as a child aged 8-12 (also known as a “tween”). In particular the user (i.e., the child) is one that is affected by child regulatory rules/laws such as the COPPA Act. The supervisor is preferably a parent, legal guardian, or any authority figure or regulator such as a teacher.

Step S110, which includes monitoring interactions of a child in a community, functions to programmatically note when actions of a user are performed. The interactions are preferably social based actions, such as a user communicating with at least one other user, participating in a group activity such as a game or forum group, sharing media such as posting/viewing videos, images, or music files, and/or any suitable action in the community. The interactions preferably occur within a first environment, which is preferably customized for the child. The first environment is preferably accessed through a first communication protocol or in other words over a first type of network. For example, the first environment may be a child social network website accessed through hypertext transfer protocol (HTTP), a child specific telephone plan accessed over a telephony network or a SMS network, email, or any suitable modality of an environment and network. The first environment and first communication protocol do not have to be the same as an environment and communication protocol used for interfacing with the supervisor, though they may have share common environments and/or communication protocols. Interactions preferably describe actions of which the child is the creator or instigator and also any action of which the child is a recipient. The interactions are typically characterized by suspicious behavior or alternatively behavior that a supervisor may wish to know about (which may be characterized by good, neutral, or bad behavior). Child interactions within the community that are preferably monitored include posts, instant messages, emails, phone calls, SMS messages, creating a group, editing a theme, adding applications, earning a badge/reward/item, friending a community user, de-friending a community user, rating something (thumbs up, star rating, liking, flagging, adding to favorites), bookmarking, playing a game, or any suitable community action. Interactions may additionally be performed with the supervisor such as by requesting permission such as requesting to join a group, add a friend, participate in a contest, purchase an item or make any community transaction, or any suitable request for permission or access to the community. The system may additionally monitor indirect interactions which are actions performed by other community users but that have a relationship or connection with the child. An indirect interaction may be a message sent by a contact of the child, a user that views media of the child, interactions of a community user that participates in a group activity with the child. The interactions are preferably pre-defined, but interactions may be dynamically generated by the system or updated based on experience, feedback, and for new features of an online community.

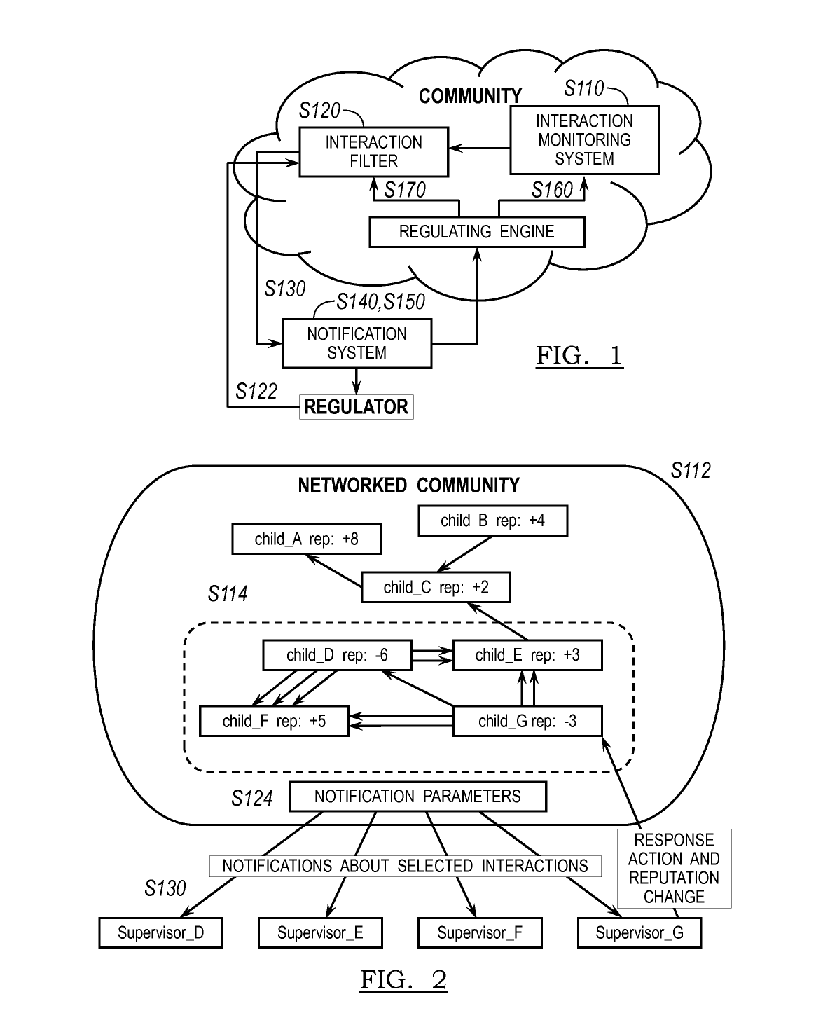

As shown in FIG. 2, step S110 preferably additionally includes monitoring interactions of the contacts of the child within the network community S112, which functions to analyze the interactions of a group of children in the networked community. The type of interactions detected by Step S112 may be characterized as group actions, where group actions are defined as interactions performed by a group of users. An individual child interaction may not warrant concern when viewed individually but may warrant classification as an interaction for notification when in context of a group. Monitoring interactions of the contacts of the child preferably enables the method to respond to interactions that are evident through a series of interactions involving a plurality of children. Monitoring of the contacts of the child preferably enables the method to select interactions related to cases such as cyber-bullying, negative group behavior, behavioral trends that can lead to bad situations, positive events, or any suitable incident or trend that is evident through a collection of interactions. As an example, a group of individuals that suddenly send messages to one user could potentially indicate a user is participating in bully-like or inappropriate behavior. As another example, a user may perform an action that would indicate the user is participating in a trend behavior. That trend behavior when viewed as a group may indicate that there are negative ramifications or possible problems if the user continues to follow the trend. Contacts of a child preferably describe any suitable entity or user that the child has interactions with through the networked community, which includes social network friends, contacts on a phone or SMS plan, or any suitable contact. The contacts of the child preferably additionally have interactions within the networked community, and these interactions are preferably monitored. The monitoring is preferably locally isolated such that interactions of an unrelated user does not impact the monitoring of the child. With the monitoring interactions of the contacts of the child within the network community S112, the method preferably additionally includes identifying patterns of child interactions S114 and selecting a set of child interactions that exhibit a pattern of interest S124. Step S112 can preferably be used to identify particular incidents that are preferably resolved through subsequent steps of the method (e.g., sending a notification to a supervisor, altering a reputation parameter of a child, and/or receiving a supervisor response action).

Step S114, which includes identifying patterns of child interactions, functions to detect defined events that involve a plurality of interactions. The patterns of child interactions may include patterns that are temporal based patterns, contact based patterns, sequence of interactions patterns, and/or any suitable pattern. A temporal based pattern preferably describes interactions that occur within a set amount of time amongst a set of users in the networked community. This pattern preferably assumes that interactions that occur close together have a possible correlation. Additionally, a single interaction of a user that is a cause for concern may result in interactions temporally associated with it being a cause for concern, as shown in FIG. 2. For example, if a user sends out five messages back-to-back to a group of related contacts and 2 of them are negative, all five messages are preferably identified by this pattern and preferably selected in Step S124. A contact based pattern preferably describes interactions that involve a particular user or group of users. These users may have been flagged as have a negative reputation parameter, and interactions involving the particular user may be selected for notification of the supervisor. A sequence of interactions pattern preferably describes interactions that are identified by an order of interactions. For example, if a child sends a plurality of messages to contacts without receiving any responses, the incident is preferably selected for notification, as there is possibly some reason behind the number of ignored messages. The pattern may alternatively be based on any suitable pattern parameters or combination of pattern parameters.

Step S120, which includes selecting interactions of the child based on a notification parameter of a supervisor, functions to select interactions that warrant notification of a supervisor. The notification parameters are preferably a set of rules for various types of interactions. The notification parameters may be discrete in nature (e.g., send notification or do not send notification) or the notification parameters may be defined on a metric or scale such as an importance level. Threshold levels associated with metrics may additionally be used to trigger a notification. One threshold level may be the maximum, minimum, or average value of the reputation parameters of children involved in the selected interactions. Three exemplary parameters that may be used to define a notification parameter include time, contact, and content parameters. Rules for specific or groups of actions are preferably set. Additionally, notification parameters preferably have associated notification actions such as the form of notification that should be implemented when an action requires notification (e.g., email, SMS, etc.). Additionally, automatic response actions may be implemented within the online community based on a child action. In one variation, the steps of monitoring interactions of a child and selecting interactions of the child may be performed in substantially the same step such that the notification parameters define the actions that are monitored.

A time parameter preferably allows for any time-based rule to be implemented. Time of day, frequency of actions, duration of actions or events, or any suitable time based rule may be used. As a first example, an action may be allowed when performed during allowed action times such as during the afternoon, but an action may require notification when an action occurs at irregular hours such as late at night. As a second example, an action such as messaging a user may require notification if the number of occurrences of an action occurs above a set number in a given amount of such as sending 30 messages in one hour. In a third example, an action may require notification if a child participates in an activity for over a set time limit, such as playing a game more than 7 hours in a week.

A contact parameter preferably defines rules based on any suitable user-to-user relationship. A contact parameter preferably relates to community members that are involved with an interaction. A contact notification parameter preferably selects interactions based interactions being associated with defined contacts. Contacts are preferably community users with whom the child is friends or has established a community or social connection. The contacts are preferably organized into friend lists such as approved friends, un-known friends, or dis-trusted friends. Smart friend lists may additionally be used to automatically organize friends. Examples of smart friend lists include new connections, most popular connections, decreased-popularity (connections a child has reduced communication with), mutual friend groupings, and any suitable automatically generated friend list. Other parameters such as geographic location, age, sex, grade, school affiliation, class affiliation, sports affiliation, or any suitable parameter may additionally or alternatively be used. Contacts may additionally be given ratings such that when a group action occurs, a group with more trusted friends may negate one not-trusted friend and vice-versa. Connection ratings (or trustworthiness) of a user may additionally be aggregated from a plurality of supervisors to suggest an average rating or to set a default rating level for a connection. Contacts may additionally be sorted or specified by corresponding reputation parameters. Reputation parameters are preferably associated with individual users such as the child and the contacts of the child. A reputation parameter is preferably a construct used to characterize the positive and/or negative qualities of a user. As is described below, a reputation may be impacted based on the interactions of a child and/or the action responses of a supervisor. A contact may alternatively be specified by username or real name.

A content filter parameter preferably depends on the content related to an action. A content filter parameter may include set trigger words or tags that are detected in an action. For example, contents of written message or accessed or posted media such as audio, video, or image may be used as a content filter parameter.

As mentioned above, Step S124, which includes selecting a set of child interactions that exhibit a pattern of interest, functions to identify the users and corresponding interactions that are involved in an incident or group behavior. Step S124 is preferably a step when additionally or alternatively monitoring the interactions of contacts of a child, and Step S124 preferably responds to a group incident. A pattern of interest is preferably any suitable interest for which notification is a possible response. The involved interactions (interactions of the child and interactions of the contacts of the child) may be selected for notification automatically. The interactions may alternatively be selected based on interactions that satisfy a notification parameter of the supervisor. So for example, when monitoring interactions of the contacts of a child, notifications may be sent to the corresponding supervisors of a plurality of children involved in the group behavior. But in some situations, a supervisor may not have a notification parameter that specifies notification based on the particular group activity so alternatively a subset of supervisors may be notified.

Step S130, which includes notifying a supervisor of interactions of the child, functions to update an authority figure of actions of a child. The form of notification is preferably defined as part of the notification parameter. The notification is preferably sent to a second environment that is specific for the supervisor such as a parent version of a social network webpage. The second environment may additionally be accessed through a second communication protocol such that a child and a supervisor may have different environments (or portals) to interact through the networked community, and also access the networked community through different modes of technology. A notification may be en email, an SMS, an automated telephone call, an IM, a message pushed to a desktop application, a message pushed to a phone application, or any suitable message delivery system. The notifications are preferably sent in real time such that they receive them as an interaction is occurring or has just occurred. The notifications may alternatively be sent in a collection of notifications or digest form that is sent hourly, daily, weekly, monthly, and/or with any suitable frequency. The notification preferably describes the interaction and may additionally include other social connections associated with the interaction or any suitable details. The notification may be a summarized description, and may include a link to a detailed description. The notification may alternatively include saving a description of the child actions for future viewing/review. Messages may be logged, recorded, transcribed, or recorded in any suitable fashion, and the messages are preferably saved in a database that may be accessed at any time by the supervisor. A supervisor preferably logs into a supervisor portion of a website to access the saved notifications.

The method of the preferred embodiment may additionally include the steps of providing a response input interface in the notification S140, and receiving a supervisor response action S150. Steps S140 and S150 function to gather input by the supervisor to alter the child interaction in the community. The input interface is preferably a menu of optional responses that a supervisor may select from. The input interface is preferably a variety of links that, when accessed, communicate the supervisor response action. A response action by the supervisor is preferably optional such that the notification may be used for informational purposes but may additionally be acted upon. In some situations, receiving of a supervisor response action is required to complete an interaction by a child. The input interface may alternatively be any suitable computer input interface such as a slider, check box, text entry field, or any suitable input field. The input may alternatively be obtained through a natural language response by the supervisor. So for example, if an SMS is sent to a parent, “Do you want to allow Jonathan to add Matt as a friend?” an SMS reply of “YES” by the supervisor preferably, the system preferably receives an affirmative response and would allow the friend request. The input in one variation is used to obtain feedback regarding the importance or how critical the notification seemed to the supervisor. In another option the input preferably functions to approve of or regulate actions within the community.

As an additional alternative step, the method of the preferred embodiment may include performing an action within the networked community associated with the supervisor response action S160, which functions to respond to the actions of the child in the community. The input interface may allow an action to occur (such as adding a friend), prevent an action (such as preventing a message from being sent), modify an action (editing a message), sending a private message (such as sending a reprimand to a child), setting a new restriction, or any suitable action regarding the interaction of the child in the community. The action of the supervisor may have negative effects (punishments or restrictions), but may alternatively have positive effects (granting rewards or allowing actions). The actions may additionally impact the reputation parameter of the child, either positively for good behavior or negatively for bad behavior.

As an additional alternative step, the method of the preferred embodiment may include dynamically modifying notification parameters based on the input of the supervisor S170. Step S170 is preferably performed when the gathered input is associated with the importance of an alert. If notifications of a similar nature (such as for the similar actions) are repeatedly ignored, the notification parameter is preferably modified to ignore future actions of a similar nature. If the notifications are repeatedly marked as important, critical, or if a response action is often made, then the system may modify the notification parameter to lower thresholds or any suitable action such that other actions related to the other important notifications also trigger a notification.

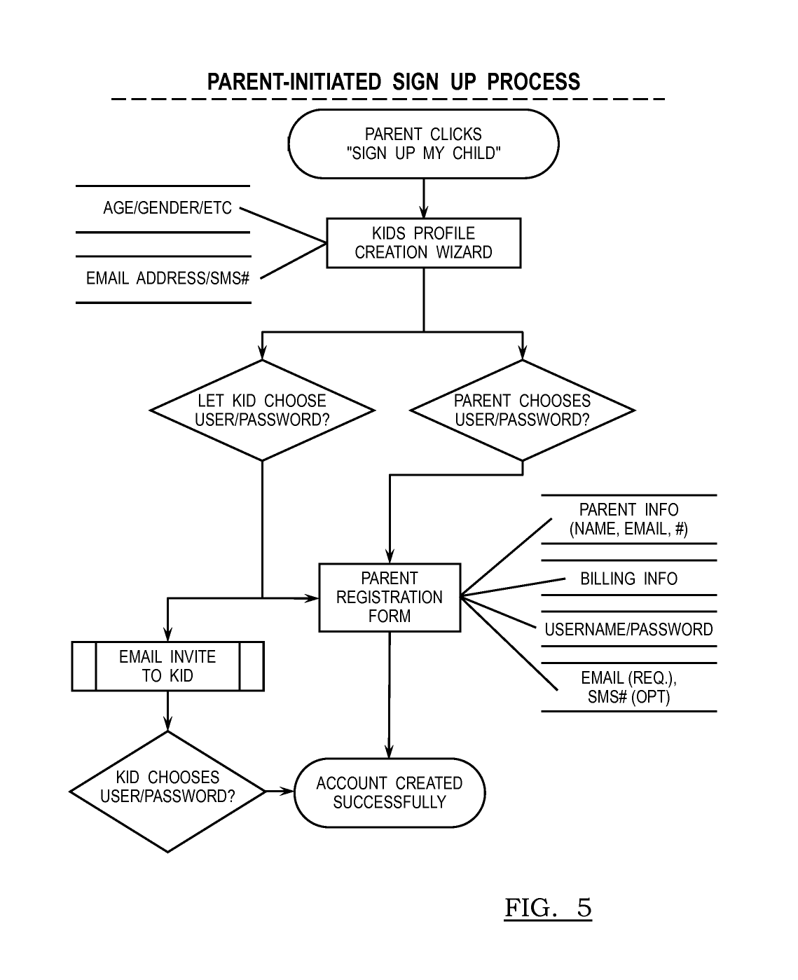

As an additional step, the method may include creating a notification parameter defined by the supervisor S122, which functions to allow a supervisor to directly customize the type of notifications and response actions. The notification parameters are preferably created by selected pre-made rules. The notification parameters may alternatively be created by creating rules (preferably using Boolean operators or selecting from a preset list) based on notification parameters and setting response actions. For a given filter any suitable response action or notification may be set. The supervisor may set up a notification to send an email, a SMS, an automated telephone call, an IM, a message pushed to a desktop application, a message pushed to a phone application, and/or any suitable message. The supervisor may additionally or alternatively enable logging of actions, which can be stored in a database to be reviewed at a later time. The supervisor may additionally set automatic response actions that are automatically implemented at the occurrence of an action. These response actions may be specific for the type of action of the child. For example, a friend request from a child may automatically be allowed but a notification still sent to the supervisor for informational purposes. As another example, pictures posted to a site may not become public until the supervisor submits approval through a response action. The supervisor is preferably able to create any number of notification parameters. The supervisor may additionally be able to modify any existing notification parameter. The supervisor preferably creates the notification parameters by going through a control panel on a supervisor portion of a website. Notification parameters are preferably setup by the supervisor during an initial use of a community, along with setting up any other personal settings, or child settings such as shown in FIGS. 4 and 5. However, notification parameters are preferably editable and may be created at any suitable time.

Additionally or alternatively, the method preferably includes altering a reputation parameter, which functions to adjust a reputation parameter of a child and/or contact may based on a supervisor response, settings of a notification parameter and/or an identified pattern. If the interactions of the child (e.g., within the pattern of child interactions) indicate the child has behaved poorly, the reputation parameter of the child is preferably negatively altered. If the interactions of the child within the pattern of child interactions indicate the child has behaved positively, the reputation parameter of the child is preferably positively altered. Additionally, the method preferably enables individual negative incidents to not impact a child for an indefinite period of time. In other words, a child is preferably enabled to redeem oneself over time and/or through positive behavior. This preferably functions to allow children to be forgiven from minor indiscretions and preferably learn from mistakes. After a reputation parameter has been negatively altered based on the identified pattern of interest, the reputation parameter is preferably positively altered after a conditional period of time. The conditional period of time may simply be a set amount of time. So for example, if a child misbehaves multiple times and receives a very negative reputation. If the child does nothing for a set amount of time (such as a month) the reputation preferably returns to a neutral reputation or more positive reputation. The conditional amount of time may alternatively or additionally include requirements such as that the user must have a set amount of interactions with out incident before positively adjusting the reputation parameter or any suitable requirements.

### 2. System of the Preferred Embodiment

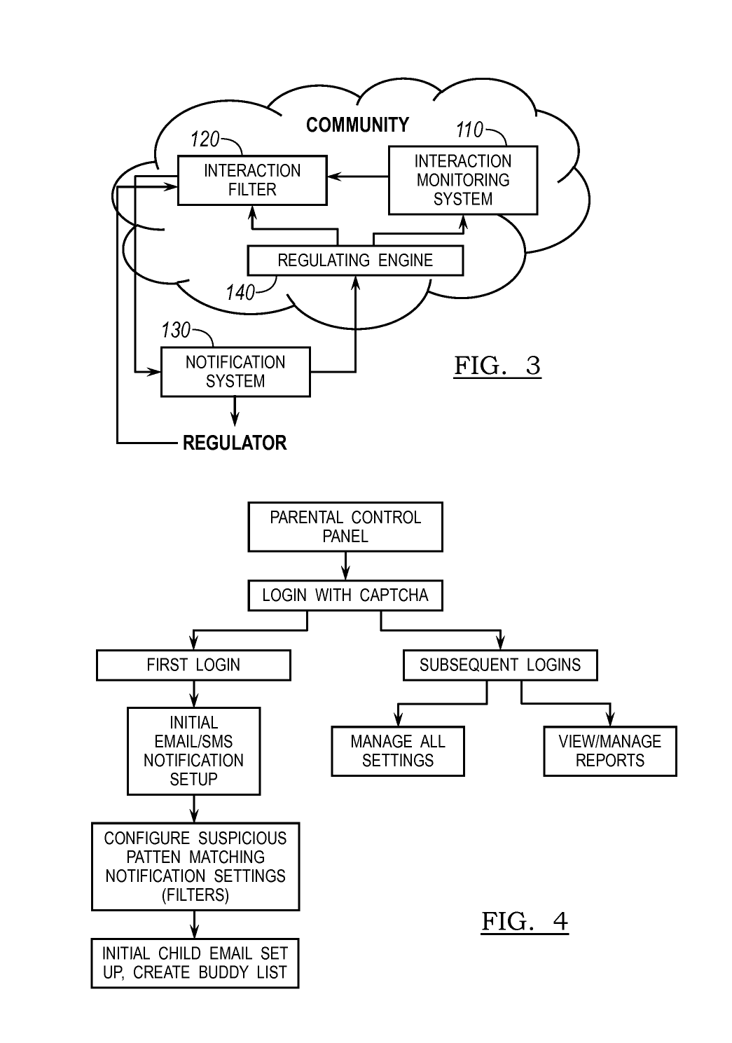

As shown in FIG. 3, a system of the preferred embodiment includes an interaction monitoring system 110 within a networked community, an interaction filter 120, a supervisor notification system 130 accessible by the supervisor, and a regulating engine 140 within the community. The interaction monitoring system 110 functions to detect interactions by the user and perform the tasks substantially similar to Step S110. The interaction filter 120 functions to identify the important actions that require notification such as performed in Step S120 and optionally, Steps S122 and S170. The supervisor notification system 130 functions to be any medium in communication with the community that can receive notifications and provide feedback such as performed in Steps S130, S140, and S150. The regulating engine 140 functions to implement any supervisor actions such as performed in Steps S160 and S170.

The system may additionally include a control panel that functions as a main portal to set and review global settings, filters, user actions, and response actions, and any suitable administrative information. The control panel is preferably part of the supervisor portion of an environment (such as a website), but may alternatively be a software application or any suitable medium for a control panel. The control panel preferably allows viewing and editing of personal settings of a supervisor and of the user such as a phone number, email address, spouse or secondary phone number, frequency of contact, notification types (setting filters), and any suitable personal information. Community settings for the user are additionally viewable and editable from the control panel such as allowing SMS, allowing IMs, allowing email, time limits, age rating limits (such as video game ratings or Motion Picture Association of America (MPAA) ratings), and/or any suitable community setting. Community connections (a buddy list) are additionally editable through the control panel. The supervisor preferably can remove connections, block connections, approve connections, organize connections into lists and/or perform any suitable task related to the community connections. The supervisor preferably uses the control panel during the initial use of the community to set up an account for a user. The control panel is preferably accessible at anytime for modification of settings.

An alternative embodiment preferably implements the above methods in a computer-readable medium storing computer-readable instructions. The instructions are preferably executed by computer-executable components preferably integrated with a children focused network community. The computer-readable medium may be stored on any suitable computer readable media such as RAMs, ROMs, flash memory, EEPROMs, optical devices (CD or DVD), hard drives, floppy drives, or any suitable device. The computer-executable component is preferably a processor on a server or device but the instructions may alternatively or additionally be executed by any suitable dedicated hardware device.

As a person skilled in the art will recognize from the previous detailed description and from the figures and claims, modifications and changes can be made to the preferred embodiments of the invention without departing from the scope of this invention defined in the following claims.

We claim:

1. A method for moderating child interaction in a networked community by a supervisor comprising:
monitoring interactions of a child within a first environment;
selecting a child interaction that satisfies a notification parameter of the supervisor; and
sending a notification to the supervisor within a second environment with information associated with the selected interaction.

2. The method of claim 1, wherein monitoring interactions includes monitoring interactions of the contacts of the child within the networked community.

3. The method of claim 2, wherein monitoring contacts of the child further comprises:
identifying patterns of children interactions; and
selecting a set of interactions that exhibit a pattern of interest.

4. The method of claim 3, wherein the patterns of children interactions is a temporal based pattern.

5. The method of claim 3, wherein the child and the contacts of the child each have an associated reputation parameter; and further comprising altering at least one reputation parameter based on the identified pattern of children interaction.

6. The method of claim 5, wherein altering the at least one reputation parameter comprises negatively altering the at least one reputation parameter, and further comprising positively altering the at least one reputation parameter after a conditional period of time.

7. The method of claim 1, wherein the first environment is accessed through a first communication protocol and the second environment is accessed through a second communication protocol.

8. The method of claim 7, wherein the first environment is a website accessed through the first communication protocol that is a hypertext transfer protocol (HTTP) and wherein the second communication protocol is short message service (SMS).

9. The method of claim 1, further comprising providing a response input interface with the notification.

10. The method of claim 9, further comprising:
receiving a supervisor response action; and
performing an action within the networked community associated with the supervisor response action.

11. The method of claim 10, wherein the notification parameter contains a threshold, wherein the child interaction is selected if the threshold is satisfied.

12. The method of claim 11, further comprising modifying the threshold of the notification parameter based on the supervisor response action.

13. The method of claim 10, wherein the child has an associated reputation parameter; and further comprising negatively altering the reputation parameter if the supervisor response action is negative; and positively altering the reputation parameter if the supervisor response action is positive.

14. The method of claim 10, wherein performing an action includes rewarding the child if the supervisor response action is positive and penalizing the child if the supervisor response actions is negative.

15. The method of claim 10, wherein performing an action includes editing content associated with the child interaction.

16. The method of claim 1, further comprising receiving customization of the notification parameter from the supervisor.

17. The method of claim 16, wherein the notification parameter is a time-based rule that selects interactions based on timing attributes of the interaction.

18. The method of claim 16, wherein the notification parameter is a content based rule that selects interactions based on content associated with the interaction.

19. The method of claim 16, wherein the notification parameter is a contact based rule that selects child interactions associated with a defined contact.

20. A system for moderating child interaction in a networked community by a supervisor comprising:
an interaction monitoring system integrated with the networked community;
an interaction filter that selects an interaction based on notification parameters;
a supervisor notification system that communicates a notification to an environment of the supervisor for a selected interaction;
wherein the notification describes the interaction and includes a response input interface; and
a regulating engine that receives a response action communicated through the supervisor notification system and performs a response action associated with the response action within the networked community.
